(19) United States
(12) Patent Application Publication
(10) Pub. No.: US 2015/0339145 A1
(43) Pub. Date: Nov. 26, 2015

(54) VIRTUAL MACHINE SERVICE SYSTEM AND VIRTUAL MACHINE SERVICE PROVIDING METHOD THEREOF

(71) Applicant: ELECTRONICS AND TELECOMMUNICATIONS RESEARCH INSTITUTE, Daejeon (KR)

(72) Inventors: Dae Won KIM, Daejeon (KR); Seong Woon KIM, Daejeon (KR); Hag Young KIM, Daejeon (KR); Wan CHOI, Daejeon (KR)

(73) Assignee: Electronics and Telecommunications Research Institute, Daejeon (KR)

(21) Appl. No.: 14/313,150

(22) Filed: Jun. 24, 2014

(30) Foreign Application Priority Data
May 26, 2014 (KR) 10-2014-0063239

(51) Int. Cl. G06F 9/455

(52) U.S. Cl. CPC G06F 9/45558; G06F 2009/45591; G06F 2009/4557; G06F 2009/45595

(57) ABSTRACT

Disclosed is a virtual machine service system, including: one or more virtual machines connected to a network through connection with virtual network interfaces provided from a first network card or connection with a second network card; a management module monitoring network usage of one or more virtual machines and reallocating the virtual network interfaces to one or more virtual machines according to a monitoring result; and an agent module providing to the management module network connection information of one or more virtual machines.

### CROSS-REFERENCE TO RELATED APPLICATIONS

This application claims priority to and the benefit of Korean Patent Application No. 10-2014-0063239 filed in the Korean Intellectual Property Office on May 26, 2014, the entire contents of which are incorporated herein by reference.

### TECHNICAL FIELD

The present invention relates to a virtual machine service system and a virtual machine service providing method thereof.

### BACKGROUND ART

Virtualization is technology that constitutes a plurality of virtual machines having an independent software execution environment in one hardware device. When the virtualization technology is applied to a server, a plurality of servers can be driven in one hardware device. Therefore, in recent years, server virtualization technology has been widely used, in which a plurality of virtual machines is driven in one server by applying the virtualization technology to the server to save hardware cost. Under such a server virtualization environment, network I/O virtualization technology is used for the plurality of virtual machines to share one network card. However, when network I/O virtualization is supported by using software, sufficient network I/O performance cannot be provided.

Therefore, virtualization supporting methods using hardware have been proposed and for example, a single root I/O virtualization (SR-IOV) structure has been suggested. The network card to which the SR-IOV structure is applied supports the network I/O virtualization without a help of the software. Accordingly, the sufficient network I/O performance can be provided under the server virtualization environment through the network card to which the SR-IOV structure is applied.

### SUMMARY OF THE INVENTION

The present invention has been made in an effort to provide a virtual machine service system and a virtual machine service providing method thereof that can further improve network I/O performance under a server virtualization environment using a network card to which a virtualization supporting structure using hardware is applied.

The technical objects of the present invention are not limited to the aforementioned technical objects, and other technical objects, which are not mentioned above, will be apparent to those skilled in the art from the following description.

An exemplary embodiment of the present invention provides a virtual machine service system, including: one or more virtual machines connected to a network through connection with virtual network interfaces provided in a first network card or a second network card; a management module monitoring network usage of one or more virtual machines and reallocating the virtual network interfaces to one or more virtual machines according to a monitoring result; and an agent module providing to the management module network connection information of one or more virtual machines.

In the exemplary embodiment, the first network card may be a network card to which a virtualization supporting structure using hardware is applied.

In the exemplary embodiment, the management module may reallocate the virtual network interface provided in the first network card to a virtual machine having larger network usage than a reference value among one or more virtual machines based on the monitoring result.

In the exemplary embodiment, the virtual machine having the larger network usage than the reference value among one or more virtual machines may be connected to the network through connection with the second network card.

In the exemplary embodiment, the first network card may be a network card to which an SR-IOV structure is applied.

In the exemplary embodiment, the management module may allocate any one of the virtual network interfaces provided in the first network card to use the allocated virtual network interface as a dedicated interface.

In the exemplary embodiment, the agent module and the management module may operate on a hypervisor or a virtual machine monitor.

Another exemplary embodiment of the present invention provides a virtual machine service providing method, including: providing network connection to one or more respective virtual machines by using one or more virtual network interfaces provided from a first network card or a second network card; monitoring network usage of one or more virtual machines; and reallocating one or more virtual network interfaces to one or more virtual machines based on the monitoring result.

In the exemplary embodiment, the first network card may be a network card to which a virtualization supporting structure using hardware is applied.

In the exemplary embodiment, in the reallocating of one or more virtual network interfaces to one or more virtual machines based on the monitoring result, one or more virtual network interfaces provided in the first network are reallocated to a virtual machine having larger network usage than a reference value among one or more virtual machines.

In the exemplary embodiment, the virtual machine having the larger network usage than the reference value among one or more virtual machines may be connected to a network by using the reallocated virtual network interface.

According to exemplary embodiments of the present invention, a virtual machine service system and a virtual machine service providing method thereof can further improve network I/O performance by dynamically allocating a network resource under a server virtualization environment using a network card to which a virtualization supporting structure using hardware is applied.

### BRIEF DESCRIPTION OF THE DRAWINGS

FIG. 1 is a block diagram illustrating a virtual machine service system according to an exemplary embodiment of the present invention.

FIG. 2 is a flowchart illustrating a virtual machine service providing method according to an exemplary embodiment of the present invention.

FIG. 3 is a flowchart illustrating a virtual machine service providing method according to another exemplary embodiment of the present invention.

FIG. 4 is a flowchart illustrating a virtual machine service providing method according to yet another exemplary embodiment of the present invention.

FIG. 5 is a block diagram illustrating a computing system that executes a virtual machine service providing method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the accompanying drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known art related to the present invention may obscure the understanding of the present invention, the detailed description thereof will be omitted.

Terms such as first, second, A, B, (a), (b), and the like may be used in describing the components of the exemplary embodiments according to the present invention. The terms are only used to distinguish a constituent element from another constituent element, but nature or an order of the constituent element is not limited by the terms. Unless otherwise defined, all terms used herein including technological or scientific terms have the same meaning as those generally understood by a person with ordinary skill in the art to which the present invention pertains. Terms which are defined in a generally used dictionary should be interpreted to have the same meaning as the meaning in the context of the related art, and are not interpreted as an ideally or excessively formal meaning unless clearly defined in the present invention.

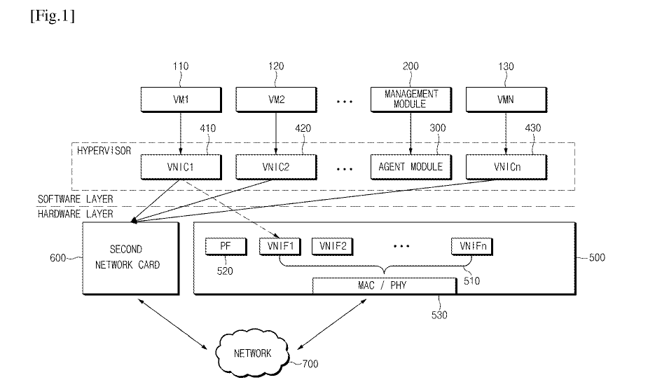

The present invention relates to a virtual machine service system and a virtual machine service providing method thereof. Hereinafter, a virtual machine service system and a virtual machine service providing method thereof according to exemplary embodiments of the present invention will be described with reference to FIGS. 1 to 5.

FIG. 1 is a block diagram illustrating a virtual machine service system according to an exemplary embodiment of the present invention.

Referring to FIG. 1, the virtual machine service system according to the exemplary embodiment of the present invention may include one or more virtual machines 110, 120, and 130, a management module 200, an agent module 300, one or more virtual network interface cards 410, 420, and 430, a first network card 500, and a second network card 600.

The virtual machine service system according to the exemplary embodiment of the present invention may include a software layer and a hardware layer.

For example, the software layer may be driven on an operating system (OS) of the virtual machine service system. The software layer may include one or more virtual machines 110, 120, and 130, the management module 200, the agent module 300, and one or more virtual network interface cards 410, 420, and 430.

The hardware layer may support network connection of the software layer. The hardware layer may include a first network card 500 and a second network card 600. The first network card 500 may be, for example, a network card to which a virtualization supporting structure using hardware is applied. The virtualization supporting structure using the hardware may include, for example, a single root I/O virtualization (SR-IOV) structure. The second network card 600 may be a general network card.

One or more virtual machines 110, 120, and 130 may be created by a hypervisor. However, the present invention is not limited thereto and the hypervisor illustrated in FIG. 1 may be substituted with a virtual machine monitor (VMM). One or more virtual machines 110, 120, and 130 may be connected to the first network card 500 or the second network card 600 through one or more virtual network interface cards 410, 420, and 430, respectively. Further, each of the one or more virtual machines 110, 120, and 130 may be connected to a network 700 through a virtual network interface 510 of the first network card 500 allocated form the management module 200 or the second network card 600. For example, the virtual network interface 510 may be driven based on the hardware. One or more respective virtual machines 110, 120, and 130 may also be called virtual desktops.

The management module 200 may provide network connection to one or more virtual machines 110, 120, and 130. The management module 200 may allocate one or more virtual respective machines 110, 120, and 130 to virtual network interfaces 510, 520, and 530 of the first network card 500 or the second card 600 through one or more virtual network interface cards 410, 420, and 430.

For example, the management module 200 may provide network connection to one or more virtual machines 110, 120, and 130 based on network connection information transferred from the agent module 300. For example, the network connection information may mean information representing through which path one or more virtual machines 110, 120, and 130 are connected to the network. Hereinafter, for easy description, a description will be made by assuming that a first virtual machine (VM1) 110 to an n-th virtual machine (VMn) 130 are connected to the second network 600 through the virtual network interfaces 410, 420, and 430, respectively and connected to the network 700 through the second network card 600.

The management module 200 may monitor network usage of one or more virtual machines 110, 120, and 130. For example, the management module 200 may monitor the network usage of one or more virtual machines 110, 120, and 130 according to a predetermined cycle. The management module 200 may reset the network connection to one or more virtual machines 110, 120, and 130 based on a monitoring result. For example, the management module 200 may change the network connection of a virtual machine (for example, the first virtual machine 110) having the network usage larger than a reference value among one or more virtual machines 110, 120, and 130 to the network connection of the virtual network interface (VNIF1) 510 of the first network card 500 based on the monitoring result.

The management module 200 may be implemented by, for example, one of one or more virtual machines 110, 120, and 130. Further, the management module 200 may be implemented on other computer to be connected to the network through an appropriate interface or may be implemented in the hypervisor.

The agent module 300 may provide to the management module 200 the network connection information to one or more virtual machines 110, 120, and 130. The agent module 300 may be driven on the hypervisor or the virtual machine monitor (VMM).

The first network card 500 may be the network card to which the virtualization supporting structure using the hardware is applied. The virtualization supporting structure using the hardware may be, for example, the single root I/O virtualization (SR-IOV) structure. The first network card 500 may include one or more virtual network interfaces 510, a physical function (PF) 520, and an MAC/PHY 530. One or more virtual network interfaces 510 may provide connection with the network 700 and operate based on the PF 520. The MAC/PHY 530 may be defined as an MAC layer and a physical layer.

As described above, the virtual machine service system according to the exemplary embodiment of the present invention may monitor the network usage of one or more virtual machines 110, 120, and 130 and reallocate one or more virtual network interfaces 510 to one or more virtual machines 110, 120, and 130 according to the monitoring result. Accordingly, the virtual machine service system according to the exemplary embodiment of the present invention allocates the virtual network interface (VNIF1) 510 of the first network 500 to the virtual machine (for example, the first virtual machine) when the network usage of the virtual machine (for example, the first virtual machine) connected to the network through the second network card 600 is larger than a reference value, thereby improving the network I/O performance. Consequently, the virtual machine service system according to the exemplary embodiment of the present invention may further improve the network I/O performance by dynamically allocating the network resource under the server virtualization environment using the network card 400 to which the virtualization supporting structure using the hardware is applied.

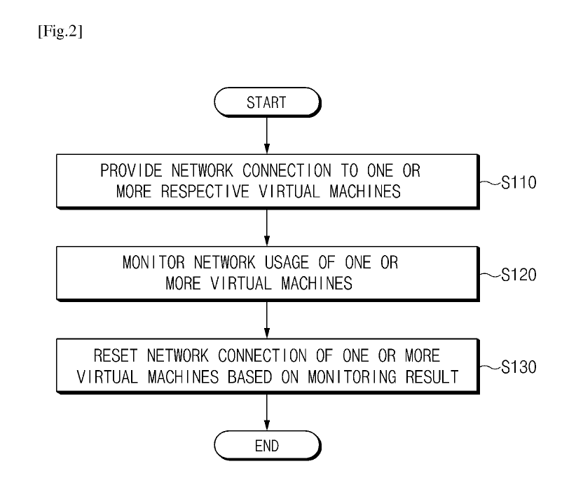

FIG. 2 is a flowchart illustrating a virtual machine service providing method according to an exemplary embodiment of the present invention.

Referring to FIG. 2, the virtual machine service providing method according to the exemplary embodiment of the present invention may include providing network connection to one or more respective virtual machines (S110); monitoring network usage of one or more virtual machines (S120); and resetting the network connection of one or more virtual machines based on a monitoring result (S130).

Hereinafter, steps S110 to S130 which are described above will be described in detail with reference to FIGS. 1 and 2.

In step S110, a management module 200 may provide network connection to one or more virtual machines 110, 120, and 130 through a first network card 500 and/or a second network card 600. For example, it is assumed that the management module 200 provides the network connection to one or more virtual machines 110, 120, and 130 through the second network card 600. The first network card 500 may be, for example, the network card to which the virtualization supporting structure using the hardware is applied. For example, the management module 200 may provide the network connection to one or more virtual machines 110, 120, and 130 based on network connection information transferred from an agent module 300.

In step S120, the management module 200 may monitor the network usage of one or more virtual machines 110, 120, and 130. For example, the management module 200 may monitor the network usage according to a predetermined cycle.

In step S130, the management module 200 may reset the network connection of one or more virtual machines 110, 120, and 130 based on the monitoring result. The management module 200 may reset the network connection of one or more virtual machines 110, 120, and 130 according to various references. For example, the management module 200 compares the network usage of one or more virtual machines 110, 120, and 130 with the reference value to reset the network connection. For example, the management module 200 allocates the virtual network interface (VNIF1) 510 of the first network 500 to the virtual machine (for example, the first virtual machine) when the network usage of the virtual machine (for example, the first virtual machine) connected to the network through the second network card 600 is larger than the reference value, thereby improving the network I/O performance.

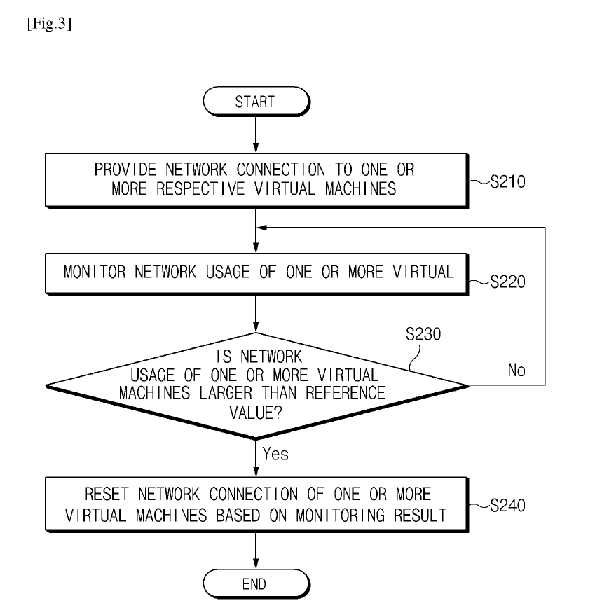

FIG. 3 is a flowchart illustrating a virtual machine service providing method according to another exemplary embodiment of the present invention. In FIG. 3, a difference from the virtual machine service providing method illustrated in FIG. 2 will be primarily described in order to avoid unnecessary duplication of the description.

Referring to FIG. 3, the virtual machine service providing method according to another exemplary embodiment of the present invention may include providing network connection to one or more respective virtual machines (S210); monitoring network usage of one or more virtual machines (S220); judging whether the network usage of one or more virtual machines is larger than a reference value (S230); and resetting the network connection of one or more virtual machines (S240).

Since steps S210 and S220 which are described above may be substantially the same as steps S110 and S120 which are described with reference to FIG. 2, steps S230 and S240 will be primarily described hereinbelow.

In step S230, the management module 200 may judge whether the network usage of one or more virtual machines is larger than the reference value based on the monitoring result. As the judgment result, when the network usage of one or more virtual machines is larger than the reference value, step S240 may be performed. As the judgment result, when the network usage of all of the virtual machines is not larger than the reference value, step S220 may be performed.

In step S240, the management module 200 may reset the network connection of one or more virtual machines. In detail, the management module 200 may reset the first virtual machine 110 to be connected to the network 700 through the virtual network interface (VNIF1) 510 of the first network card 500 when the network usage of the virtual machine (for example, the first virtual machine 110) among one or more virtual machines 110, 120, and 130 is larger than the reference value.

The management module 220 is not limited thereto and when the network usage of one or more virtual machines 120 and 130 is larger than the reference value, the management module 220 may reallocate the virtual network interfaces (VNIF2 and VNIF3) 510 to one or more virtual machines 120 and 130.

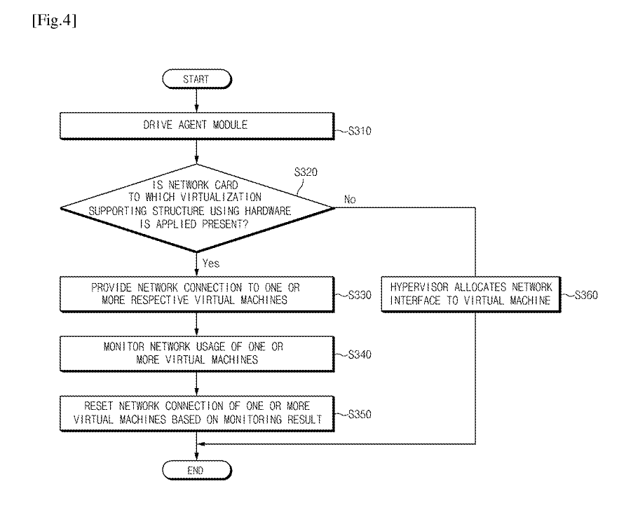

FIG. 4 is a flowchart illustrating a virtual machine service providing method according to yet another exemplary embodiment of the present invention.

In FIG. 4, a difference from the virtual machine service providing method illustrated in FIG. 2 will be primarily described in order to avoid unnecessary duplication of the description.

Referring to FIG. 4, the virtual machine service providing method according to yet another exemplary embodiment of the present invention may include driving an agent module (S310); judging whether a network card to which a virtualization supporting structure using hardware is applied is present (S320); providing network connection to one or more respective virtual machines (S330); monitoring network usage of one or more virtual machines (S340); resetting the network connection of one or more virtual machines based on a monitoring result (S350); and allocating, by a hypervisor, a network interface to one or more virtual machines (S360).

Since steps S330 to S350 which are described above may be substantially the same as steps S110 and S130 which are described with reference to FIG. 2, steps S310, S320, and S360 will be primarily described hereinbelow.

In step S310, the agent module 300 may be driven. For example, the agent module 300 may be driven on the hypervisor or the virtual machine monitor (VMM).

In step S320, the agent module 300 may sense whether the network card to which the virtualization supporting structure using the hardware is applied is present. For example, the agent module 300 may sense whether the first network card 500 is installed in the virtual machine service system.

In step S360, the hypervisor or the virtual machine monitor (VMM) may allocate the network interface to one or more virtual machines 110, 120, and 130 (see FIG. 1). That is, step S360 may be appreciated as a network interface allocating process through general software. Step S360 may be performed when the first network card 500 and the second network card 600 are not installed in the virtual machine service system.

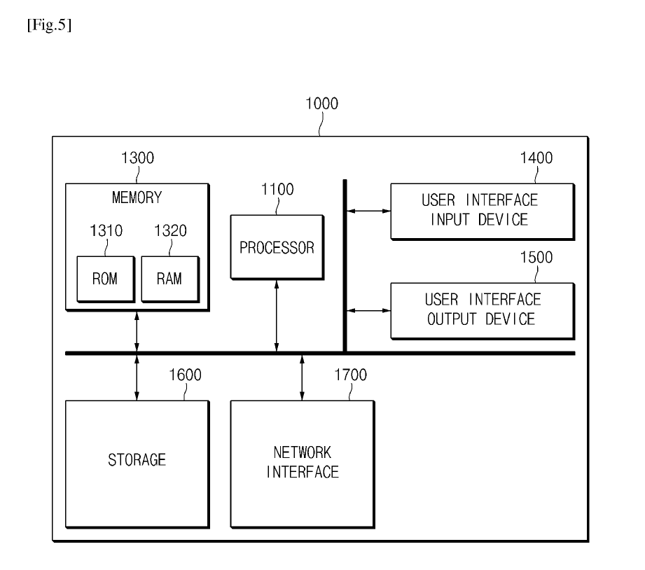

FIG. 5 is a block diagram illustrating a computing system that executes a virtual machine service providing method according to an exemplary embodiment of the present invention.

Referring to FIG. 5, the computing system 1000 may include one or more processors 1100 connected through a bus 1200, a memory 1300, a user interface input device 1400, a user interface output device 1500, a storage 1600, and a network interface 1700.

The processors 1100 may be a central processing unit (CPU) or a semiconductor device that processes commands stored in the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal As yet another method, the processor and the storage medium may reside in the user terminal as individual components.

Various exemplary embodiments of the present invention have been just exemplarily described, and various changes and modifications may be made by those skilled in the art to which the present invention pertains without departing from the scope and spirit of the present invention. Accordingly, the embodiments disclosed herein are intended not to limit but to describe the technical spirit of the present invention, and the scope of the spirit of the present invention is not limited to the embodiments. The scope of the present invention may be interpreted by the appended claims and all the technical spirits in the equivalent range thereto are intended to be embraced by the claims of the present invention.

What is claimed is:

1. A virtual machine service system, comprising:
one or more virtual machines connected to a network through connection with virtual network interfaces provided from a first network card or connection with a second network card;
a management module monitoring network usage of one or more virtual machines and reallocating the virtual network interfaces to one or more virtual machines according to a monitoring result; and
an agent module providing to the management module network connection information of one or more virtual machines.

2. The system of claim 1, wherein the first network card is a network card to which a virtualization supporting structure using hardware is applied.

3. The system of claim 2, wherein the management module reallocates the virtual network interface provided from the first network card to a virtual machine having larger network usage than a reference value among one or more virtual machines based on the monitoring result.

4. The system of claim 3, wherein the virtual machine having the larger network usage than the reference value among one or more virtual machines is connected to the network through connection with the second network card.

5. The system of claim 2, wherein the first network card is a network card to which an SR-IOV structure is applied.

6. The system of claim 1, wherein the management module receives any one of the virtual network interfaces provided from the first network card to use the allocated virtual network interface as a dedicated interface.

7. The system of claim 1, wherein the agent module and the management module operate on a hypervisor or a virtual machine monitor.

8. A virtual machine service providing method, comprising:
providing network connection to one or more respective virtual machines by using one or more virtual network interfaces provided from a first network card or a second network card;
monitoring network usage of one or more virtual machines; and
reallocating one or more virtual network interfaces to one or more virtual machines based on the monitoring result.

9. The method of claim 8, wherein the first network card is a network card to which a virtualization supporting structure using hardware is applied.

10. The method of claim 9, wherein in the reallocating of one or more virtual network interfaces to one or more virtual machines based on the monitoring result, one or more virtual network interfaces provided from the first network card are reallocated to a virtual machine having larger network usage than a reference value among one or more virtual machines.

11. The method of claim 10, wherein the virtual machine having the larger network usage than the reference value among one or more virtual machines is connected to a network by using the reallocated virtual network interface.
